(19) United States
(12) Patent Application Publication
(10) Pub. No.: US 2012/0119414 A1
(43) Pub. Date: May 17, 2012

(54) PROCESS FOR MANUFACTURING A SHAPED ARTICLE FROM A COMPOSITE MATERIAL COMPRISING A SOLID FILLER AND A THERMOPLASTIC BINDER

(75) Inventor: Arend Kuindert Van Helden, Amersfoort (NL)

(73) Assignee: Echotect B.V.

(21) Appl. No.: 13/318,699

(22) PCT Filed: May 4, 2010
(86) PCT No.: PCT/NL10/50260

§ 371 Date: Jan. 17, 2012

Related U.S. Application Data
(60) Provisional application No. 61/175,527, filed on May 5, 2009.

(30) Foreign Application Priority Data
May 5, 2009 (EP) 09159407.7

(51) Int. Cl. B29C 43/22; C08L 67/02

(52) U.S. Cl. 264/239; 524/605; 524/513

(57) ABSTRACT

The present invention relates to a process for manufacturing a shaped article from a composite material comprising a solid filler and a thermoplastic binder, said process comprising the following subsequent steps: (a) feeding a solid filler and a thermoplastic binder to a kneading device; (b) mixing the solid filler and the thermoplastic binder in the kneading device, wherein the pressure exerted on the mixture of the solid filler and the thermoplastic binder is in the range of about 100 kPa to about 1500 kPa to obtain a composite material; (c) forming the composite material as obtained in step (b) into a shaped article; and (d)cooling the shaped article as obtained in step (c). The shaped article is preferably a slab which can very suitable be used in the decoration of floors, ceilings, wall panels, vanity tops, kitchen work surfaces, kitchen tops, bathrooms, internal and external cladding and other two-dimensional and three-dimensional shapes by extrusion and or injection moulding techniques.

### FIELD OF THE INVENTION

The present invention relates to a process for manufacturing a shaped article from a composite material comprising a solid filler and a thermoplastic binder. The shaped article according to the present invention can conveniently be used as decoration elements, e.g. plates or slabs, which can for example very suitable be used in construction of floors, ceilings, wall panels, vanity tops, kitchen work surfaces, kitchen tops, bathrooms, internal and external cladding and other two-dimensional and three-dimensional shapes by extrusion and or injection moulding techniques.

### BACKGROUND OF THE INVENTION

Polymers and blends thereof with appropriate components have been used for many years as a staple material for the manufacture of short-life consumer goods such as drink bottles and food containers. However, due to their low biological degradability, such polymers and blends thereof are of great concern to the environment. Recycling of such polymers and blends thereof into valuable end-use products is therefore highly desirable.

WO 02/090288, incorporated by reference herein, discloses a process for the preparation of a composition comprising a matrix of solid particles and 1-50 wt. % of a binder, wherein the binder comprises an optionally recycled thermoplastic polymer, preferably selected from the group consisting of polyethylene, polypropylene, polyethylene terephthalate, polybutylene terephthalate and mixtures thereof. It is preferred that the binder comprises recycled polyethylene terephthalate, preferably as a major component (70-90 wt. %, preferably 80-85 wt. %), even more preferably in combination with recycled polypropylene (10-30 wt. %, preferably 15-20 wt. %). According to the process disclosed in WO 02/090288, the solid particles and the binder are heated independently (the solid particles being heated to a higher temperature than the binder) and are subsequently mixed at a temperature of 230° to 300° C. Mixing of the filler and the binder is performed in a conventional mixing device comprising a stirrer or in an extruder. Optionally, a flux oil or an organic solvent is added to reduce the viscosity of the mixture. The mixture is then formed or shaped and subsequently cooled. However, the method according to WO 02/090288 has several disadvantages leading to products having inferior properties. For example, Example 14 of WO 02/090288 discloses that when the mixing is performed in a twin-screw extruder and the mixture is shaped into a construction element followed by slow cooling (“cooled in the open air”), the construction element showed shrinkage cracks which is undesirable when it is intended for the construction of end-use products requiring a highly aesthetic appearance, e.g. floors, kitchen work surfaces or kitchen tops. WO 02/090288 further discloses that cooling can conveniently be conducted rapidly, preferably by quenching with e.g. water, which would likely result into poor mechanical properties. Furthermore, such mixtures of the solid particles and the binder are highly abrasive resulting into high wear when mixing is performed in devices employing high shear forces such as extruders. Extruders have also the disadvantage that they have to be operated at relatively high pressures and that the residence time of the mixture of the solid particles and the binder is rather long which adds to thermoplastic binder degradation and high machine wear. Clearly, devices employing high shear forces require relatively high amounts of the thermoplastic binder as otherwise the viscosity of the mixture of the solid particles and the thermoplastic binder becomes too high.

WO 96/02373, incorporated by reference, discloses a method of manufacturing a multi-purpose building material from domestic waste, industrial waste or a combination thereof, wherein a waste material having a plastics material content of 20 wt. % to 65 wt. % is sheared to particles having a diameter 50 mm or less, subsequently mixed with a particulate filler at a temperature of 120° to 200° C. until a uniform mixture is obtained and finally formed into a final product. WO 96/02373 does not provide details about cooling of the final product.

GB 2396354, incorporated by reference, discloses a method for manufacturing bulk products from plastics material comprising mixing plastic particles having a mean diameter of 10 mm or less in a mixing vessel while simultaneously feeding finely divided filler material. Subsequently, a first portion of the mixture of plastic material and filler material is separated and cooled, then blended with the further heated mixture of plastic particles and filler material, and finally the blended material is shaped into a product. GB 2396354 does not disclose further details of the cooling of the shaped product.

U.S. Pat. No. 6,583,217, incorporated by reference, discloses a process for making a composite material from waste, chemically unmodified polyethylene terephthalate and 50-70 wt. % of fly ash particles, wherein the waste, chemically unmodified polyethylene terephthalate and fly ash particles are first mixed (i.e. unheated) and then heated to about 255° to about 265° C. (but not higher than about 270° C. to prevent decomposition of the waste, chemically unmodified polyethylene terephthalate) to melt the waste, chemically unmodified polyethylene terephthalate. The mixture is then shaped into a construction element and cooled. U.S. Pat. No. 6,583,217 addresses the importance of moulding temperatures and cooling rates for mechanical properties without, however, providing further details: the general method involves pouring the mixture into a mould and allowing the moulds to cool to ambient temperature in approximately two hours (irrespective the size and shape of the mould).

U.S. 2003/0122273, incorporated by reference, discloses a process for making a composite material from a filler and a thermoplastic binder, wherein the binder is an asphaltenes-containing binder having a penetration of less than 15 dmm. The mixture is then formed by compaction into the end-product which is subsequently cooled under either ambient conditions (for hours to days) or by quenching with e.g. water (that is, by immersion into a water bath or by drenching in water sprays).

U.S. Pat. No. 6,472,460, incorporated by reference, discloses a method for producing a polymeric composite material comprising melt-kneading an organophilic clay and a polymer under certain process conditions including (a) pressure and (b) total shear strain and/or total shear energy per unit volume. According to the examples, about 2 wt. % of the organophilic clay C12-Mt or C18-Mt is mixed with a nylon resin.

EP 1.197.523, incorporated by reference, discloses a method for producing an acrylic bulk moulding compound (BMC) comprising an acrylic monomer, an acrylic polymer, an inorganic filler and optionally a curing agent. The acrylic bulk moulding compound can be used to for producing an acrylic artificial marble, wherein the acrylic bulk moulding compound is filled into a mould followed by curing under heat and pressure. As a consequence, the method according to EP 1.197.523 involves a polymerization step of the unsaturated acrylic monomer.

Consequently, there is still a need in the art to provide an efficient process for mixing relatively high amounts of solid filler particles and relatively low amounts of thermoplastic binders into a composite material which does control degradation of the thermoplastic binder, enabling good product properties and which does not cause high wear to the mixing equipment used.

### SUMMARY OF THE INVENTION

The present invention relates to a process for manufacturing a shaped article from a composite material comprising a solid filler and a thermoplastic binder, said process comprising the following subsequent steps:
(a) feeding a solid filler and a thermoplastic binder to a kneading device;
(b) mixing the solid filler and the thermoplastic binder in the kneading device, wherein the pressure exerted on the mixture of the solid filler and the thermoplastic binder is in the range of about 100 kPa to about 1500 kPa to obtain a composite material;
(c) forming the composite material as obtained in step (b) into a shaped article; and
(d) cooling the shaped article as obtained in step (c).

It is preferred that the process according to the present invention is a continuous process.

The present invention also relates to a composite material comprising a solid filler and a thermoplastic binder as can be obtained by steps (a) and (b) of the process and to a shaped article as can be obtained by steps (a)-(d) of the process.

The present invention further relates to the use of the composite material for the manufacture of shaped articles, in particular floors, floor tiles, ceilings and ceiling tiles, wall panels, vanity tops, kitchen work surfaces, kitchen tops, bathrooms, internal and external cladding and other two-dimensional and three-dimensional shapes by extrusion and or injection moulding techniques.

The present invention also relates to the use of the composite material for constructing floors, floor tiles, ceilings and ceiling tiles, wall panels, vanity tops, kitchen work surfaces, kitchen work tops, bathrooms, internal and external cladding and other two-dimensional and three-dimensional shapes by extrusion and or injection moulding techniques.

### DETAILED DESCRIPTION OF THE INVENTION

### Definitions

The verb “to comprise” as is used in this description and in the claims and its conjugations is used in its non-limiting sense to mean that items following the word are included, but items not specifically mentioned are not excluded. In addition, reference to an element by the indefinite article “a” or “an” does not exclude the possibility that more than one of the element is present, unless the context clearly requires that there is one and only one of the elements. The indefinite article “a” or “an” thus usually means “at least one”.

It is well known to the person skilled in the art that kneading devices are distinct in their operation from (single screw or double screw) extruders (cf. Kirk-Ohtmer, Encyclopedia of Chemical Technology, 4^{th} Ed., Vol. 16, pages 844-887, 1995). In an single screw extruder, the polymeric binder is primarily melted by the work energy provided in the extruder and hardly by heat transfer through the wall of the extruder barrel. Because the screw of the extruder drags the polymeric melt through the extruder barrel, relatively high shear forces result between screw and barrel. Single screw extruders provide little axial mixing. Shear forces are also relatively high in double screw extruders which provide more radial mixing between the screws and also only little axial mixing. Kneaders, however, due their internal design of open screw flights and kneading pins, operate at relatively low shear forces and provide majorly axial mixing. Kneaders often also enable lower operating temperatures, lower pressures and a narrow residence time distribution. Reference is made to e.g. U.S. 2009/027994, incorporated by reference.

Although extruders are very commonly used in polymer processing, it was surprisingly found that kneader devices performed advantageously in the process according to the present invention.

In this document, the term “recycled polyethylene terephthalate” is used to indicate material originating from packaging applications, e.g. beverage bottles and food containers, comprising polyethylene terephthalate and optionally other polyesters and non-polyethylene terephthalate components such as remnants of paper labels, glues, inks and pigments, polypropylene caps and aluminium caps. The packaging applications may also have multilayered structures. They may further include ethylene vinyl acetate (EVA), nylon and other polyamides, polycarbonate, aluminium foil, epoxy resin coatings, polyvinyl chloride (PVC), polypropylene, LDPE, LLDPE, HDPE, polystyrene, thermosetting polymers, textile, and mixtures thereof. Such packaging applications may also comprise recycled (polymeric) materials. Consequently, in this document, the term “recycled polyethylene terephthalate” is preferably a material comprising about 90 wt. % to about 100 wt. % of polyethylene terephthalate and about 0 wt. % to about 10 wt. % of non-polyethylene terephthalate components, based on the total weight of the material, wherein the fraction of non-polyethylene terephthalate components preferably comprises about 0.001 wt. % to about 10 wt. %, more preferably about 0.001 wt. % to about 5 wt. % of non-polymer components, based on the total weight of the fraction of non-polyethylene terephthalate components.

The term “modified polyethylene terephthalate” is also well known in the art and refers to copolymers of ethylene glycol and terephthalic acid which further comprise monomers such as isophthalic acid, phthalic acid, cyclohexane dimethanol and mixtures thereof.

The term “total shear energy per unit volume” implies the sum of the values of the shear energy per unit volume in all loading directions of a kneaded material and is defined below:

E=η·(γ′)²·t

wherein E (Pa) is total shear energy per unit volume, η is the melt viscosity (Pa·s), γ′ (s⁻¹) is the shear rate in all loading regions and t (s) is the residence time in all loading regions. The term “loading region” is explained in U.S. Pat. No. 6,472,460, incorporated by reference herein.

According to U.S. Pat. No. 6,472,460, a total shear energy per unit volume E of less than 10¹⁰ Pa may result in insufficient mixing.

The term “ambient temperature”, although well known to the person skilled in the art, is herein defined as a temperature of about 15° C. to about 40° C.

### The Thermoplastic Binder

According to the present invention, the thermoplastic binder comprises about 60 wt. % to about 100 wt. % of a thermoplastic polyester, based on the total weight of the binder. Preferably, the thermoplastic binder comprises about 75 wt. % to about 100 wt. % of a thermoplastic polyester, more preferably about 75 wt. % to about 90 wt. % and in particular about 80 wt. % to about 85 wt. % of the thermoplastic polyester. The thermoplastic polyester is preferably selected from the group of, optionally modified, optionally recycled polyethylene terephthalate and polybutylene terephthalate. The thermoplastic polyester is most preferably recycled polyethylene terephthalate. The thermoplastic polyester has preferably an intrinsic viscosity in the range of about 0.50 dl/g to about 0.90 dl/g, more preferably about 0.60 dl/g to about 0.85 dl/g, most preferably about 0.70 dl/g to about 0.84 dl/g, at 25° C. according to ASTM D 4603.

The thermoplastic binder according to the present invention comprises about 0 wt. % to about 40 wt. % of a polyolefin, preferably about 0 wt. % to about 25 wt. %, more preferably about 10 wt. % to about 25 wt. %, and in particular about 15 wt. % to about 20 wt. %, based on the total weight of the thermoplastic binder.

The polyolefin is preferably selected from polyolefins based on linear or branched C₂-C₁₂ olefins, preferably C₂-C₁₂ α-olefins. Suitable examples of such olefins include ethylene, propylene, 1-butene, 2-butene, isobutene, 1-pentene, 1-hexene, 1-octene and styrene. The polyolefins optionally comprise a diolefin, e.g. butadiene, isoprene, norbornadiene or a mixture thereof. The polyolefins may be homopolymers or copolymers. Preferably, the polyolefins are selected from the group consisting of polyolefins comprising ethylene, propylene, 1-hexene, 1-octene and mixtures thereof. Additionally, the polyolefins may be essentially linear, but they may also be branched or star-shaped. The polyolefins are more preferably selected from polymers comprising ethylene, propylene and mixtures thereof. Even more preferably, the polyolefin is a propylene polymer, in particular a polypropylene. Preferably the density of the polyolefin is in the range of about 0.90 kg/dm³ to about 0.95 kg/dm³ according to ASTM D 792. Preferably, the melt flow rate of the propylene polymer is about 0.1 g/10 min (230° C., 2.16 kg) to about 200 g/10 min (230° C., 2.16 kg) according to ASTM D 1238.

According to the invention, the thermoplastic binder can be used in the form of grinded or milled particles having a maximum weight of 1 gram. It is, however, preferred that the thermoplastic binder is used in the form of flakes having preferably a size of about 2-10 mm by about 2-10 mm (about 0.5 mm to about 3 mm thickness).

### The Solid Filler

As the solid filler, different materials may be used. Suitable examples include mineral particles, cement particles, concrete particles, sand, recycled asphalt, recycled crumb rubber from tyres, clay particles, granite particles, fly ash, glass particles and the like. Preferably, the solid filler is a calcite based material which may be of natural or synthetic origin (such as marble) and/or a silica based material (such as quartz). Optionally, the solid filler may be constituted from different sources having different particle size distributions. However, it is preferred that that the maximum average particle size is 1.2 mm or less and that the minimum average particle size is 3 μm or more.

Mixing Step

As explained above, the mixing process according to the present invention is performed in a kneading device which, in particular for continuous processes, have distinct advantages over a mixing process wherein an extruder (in particular twin-screw extruders) is used. Kneading devices are operated at low pressure, low speed and low L/D ratios so that shear rates are very low compared to the shear rates encountered in extruders. The clearance between the barrel of the kneading device and the screw is usually greater than in an extruder which also helps in reducing maximum shear forces. In addition, residence times and residence time distributions are generally lower in kneading devices than in extruders. In addition, in an extruder, mixing and compaction occurs in a single step whereas kneading devices enable to perform compaction in a separate step. Furthermore, kneading devices operate with dispersive mixing whereas extruders operate with shear mixing.

It was surprisingly found that a separate mixing step (by kneading) followed by a separate compaction step resulted into composite materials and shaped articles having many improved properties in comparison with extruder based processes. These improves properties include in particular mechanical properties, decolouration and product degradation. Accordingly, the application of a kneading device resulted in improves mechanical properties, less decolouration and less product degradation. Another important aspect is that with a kneading device less wear of mechanical parts is observed than with extruders, which is important when the process according to the present invention is performed in a continuous manner.

According to the present invention, in step (a) the solid filler and the thermoplastic binder are fed to the kneading device in a weight ratio of about 1:1 to about 20:1. Preferably, this weight ratio is about 2:1 to about 15:1, more preferably about 4:1 to about 10:1.

According to the present invention, it is also preferred that when the solid filler and/or the thermoplastic binder are fed to the kneading device (in step (a) of the process according to the present invention) without additional heating, i.e. that the solid filler and/or the thermoplastic binder are around ambient temperature.

Furthermore, The process according to any one of the preceding claims, wherein step (b) is performed at a temperature of about 230° C. to about 350° C., more preferably at a temperature of about 270° C. to about 320° C.

It is also preferred that step (b) of the process according to the present invention is performed at a total shear energy per unit volume E of about 10⁸ Pa to about 10⁹ Pa. In extruders, the total shear energy per unit volume is usually much higher (e.g. at least 10¹⁰ Pa; cf. for example U.S. Pat. No. 6,472,460, incorporated by reference).

It is furthermore preferred that step (b) is performed for a time period of about 30 seconds to about 5 minutes.

The process according to the present invention is performed with relatively low residence times, i.e. that step (b) is performed for a time period of about 30 seconds to about 5 minutes, more preferably about 1-4 minutes. The residence time of the mixture of the solid filler and the thermoplastic binder in the kneading device is therefore significantly shorter than the residence time in an extruder as is elucidated as follows. The L/D ratio of a twin-screw extruder is around 40 whereas the L/D ratio of a kneading device is about 11. The residence time is proportional to the L/D ratio, for example as follows:

$$RT ∼ \frac{L}{π Dn}$$

wherein RT is the residence time (s) and n is the rotating speed of the screw (rpm).

In the process according to the present invention, the energy input during step (b) is at least about 300 kJ per kg mixture of the solid filler and the thermoplastic binder. Preferably, the energy input is not more than about 1000 kJ per kg mixture. More preferably, the energy input is in the range of about 400 kJ per kg mixture to about 800 kJ per kg mixture.

Extruders are very common devices for polymer processing application. During extrusion, polymer pellets are molten and mixed with various additives. Extruders also build up the pressure necessary for downstream processing. In addition, the energy supplied to the polymer melt comes primarily from two sources (i) viscous heat generated by shear between parts of the flow moving at different velocities (ii) direct heat conduction from the wall of the extruder. The former (also known as viscous internal heating) is supplied by the motor turning the screw, the latter by heating devices. To further distinguish the process according to the present invention from known processes involving the application of extruders, step (b) of the process according to the present invention is performed such that less than 80% of the total energy input into the product (which is delivered by mechanical and electrical forces) occurs by mechanical forces. Another parameter for the ratio of viscous internal heating vs. direct heat conduction is the Brinkman Number (cf. R Byron Bird, “Transport Phenomena”, Wiley & Sons, 1960, p 278). According to the present invention, it is preferred that the Brinkman number in step (b) is less than 100, preferably less than 50.

### Compaction

In extruders, mixing and compaction may occur within the same device. On the other hand, the use of a kneading device enables to perform compaction in a separate, distinct step. Accordingly, the step (b) of the process of the present invention may optionally comprise a compaction step which may be conducted simultaneously with or subsequently after the mixing step.

Preferably, the compaction step is performed in a conveying extruder which is operated at a pressure of about 5×10³ kPa to about 5×10⁴ kPa, more preferably of about 10⁴ kPa to about 3×10⁴ kPa.

### Forming

The forming step may also be conducted with devices known in the art, e.g. by compression moulding, wherein the composite material is loaded into a mould and the shaped article is formed under a load, by injection moulding, or by extrusion, wherein the material is pressed through a die into the desired shape, and a knife is used to dimension the shaped article to the desired length. The latter method is in particular advantageous when the shaped article is a wall panel, a vanity top, a kitchen work surface or a kitchen top.

### Cooling Step

According to the present invention, the cooling step may be performed by any conventional means. Hence, this step may include rapid cooling (e.g. quenching) or slow cooling or controlled cooling. However, it is preferred that the cooling steps proceeds in a controllable manner, wherein the amount of energy per weight equivalent withdrawn from the shaped article during step (d) is about 100 kJ/kg to about 250 kJ/kg, more preferably about 150 kJ/kg to about 200 kJ/kg. The amount of energy withdrawn from the shaped article is calculated as the ratio of the cooling power of the cooling device (in kW) and the throughput of the shaped article or shaped articles (in kg/s; mass flow) and is therefore expressed as kJ/kg. Hence, the amount of energy is related to the weight (in kg) of the shaped article to be cooled.

It was surprisingly found that cooling conditions had a significant impact on important properties of the shaped article according to the invention as produced along conventional process conditions. In addition, prior art processes suffered from the disadvantage that they are not very efficient, in particular because these processes make use of moulding steps to form the shaped article. Hence, the shaped article could only be manufactured batch wise, whereas continuous manufacturing would be highly desirable for efficiency and consistency of product quality.

It appeared that, in particular when the shaped article is a slab, mechanical properties could be greatly improved by applying certain stringent cooling conditions and/or by using particular cooling devices. In particular, it appeared that cooling the upper surface and the bottom surface of the slab provided improved properties, e.g. less warping, higher flexural strength, higher compression strength and less surface cracks.

According to the present invention, the cooling rate is at least about 5° C./min to about 120° C./min, more preferably at least about 7° C./min to about 100° C./min, and most preferably at least about 10° C./min to about 80° C./min.

According to the invention, the slab has preferably a thickness of about 0.3 cm to about 5 cm, more preferably about 0.5 cm to about 3.0 cm and in particular about 0.5 cm to about 2.5 cm. Furthermore, it is preferred that the slab has an average thickness of about 2.5 mm to about 50 mm, more preferably 3.0 mm to about 30 mm.

Desired properties, e.g. warping, strength and the number of surface cracks, could be further improved by performing step (d) by belt cooling.

Belt cooling such as single belt and double belt cooling, is well known in the art and is often used in the steel industry. However, steel has very different properties and must fulfil other requirements than the composite material according to the present invention.

Belt cooling is operated as follows. The shaped article to be cooled is loaded on a belt, usually made of steel. Since steel has an excellent thermal conductivity, heat can be dissipated quite rapidly. The rate of heat dissipation can be controlled by e.g. the run speed of the belt. The belt itself is cooled by external sources, e.g. sources spraying water and/or air against the belt. Preferably, when water is used as coolant, there is no contact between the shaped article and the cooling water. The cooling water can optionally be collected and, after cooling to the desired temperature, be recycled into the cooling process. It is therefore preferred that the cooling is achieved by using air, water or a combination thereof.

According to the present invention, the belt cooling can be performed by single belt cooling or double belt cooling, wherein one or more single belt cooling devices and/or one or more double belt cooling devices are used, respectively. Optionally, the cooling system may comprise a combination of one or more single belt cooling devices and one or more double belt devices. However, according to the present invention, it is preferred that at least a double belt cooling device is used.

Double belt cooling has as one advantage that the shaped articles can be produced with increased capacity, as the product is in contact with two cooling belts. Another important advantage is that the whole cooling process can be better controlled. Furthermore, double belt cooling provides more flexibility with respect to the thickness of the shaped article, i.e. that thicker articles can be cooled at about the same efficiency as less thicker products can be cooled on a single belt device.

In a double belt cooling device, the shaped article is fed onto the upper surface of the lower belt which transports it to the cooling zone or cooling zones, where the pressure of the upper belt ensures essentially constant contact with the surfaces of both the lower belt and the upper belt thereby providing an efficient and controlled cooling of the shaped article.

In cooled shaped articles, the stress distribution is dependent from the well known Biot number. The Biot number (Bi) is a dimensionless number which is used in unsteady-state (or transient) heat transfer calculations and it relates to the heat transfer resistance inside and at the surface of the shaped article. The Biot number (dimensionless) is defined as:

$$Bi = \frac{Hd}{L}$$

wherein H is the heat transfer coefficient at the surface of the shaped article (in W/m²·K), 2 d is the thickness of the shaped article (or characteristic length which is the ratio of the volume of the shaped article and the surface area of the shaped article; in m) and L is the heat conductivity of the shaped article (in W/m·K). When the Biot number is (substantially) higher than 10, the number of internal stresses increases significantly which is obviously undesired for shaped articles (in particular slabs) according to this invention. Consequently, according to the present invention, it is preferred that the Biot number is less than about 10, more preferably less than about 5. However, if the Biot number is much less than 0.1, the heat transfer within the shaped article is much greater then the heat transfer from the surface of the shaped article (which implies that there are hardly any temperature gradients within the shaped article). Hence, according to the present invention it is preferred that the Biot number is about 0.1 or higher, preferably about 0.2 or higher.

### Composite Material

According to the present invention, the density of the composite material is preferably about 1.5-3 kg/dm³, more preferably about 2.0-2.5 kg/dm³.

### Shaped Article

The shaped articles according to the present invention have several important features. For example, they are characterised by a high alkali resistance making them very suitable for constructing floors, kitchen work surfaces and kitchen tops. The shaped articles also have good mechanical properties. In particular, it is preferred that the shaped article has a flexural strength of at least about 40 N/mm² according to test method NEN EN 198-1. In addition, it is preferred that the compression strength is at least about 50 N/mm² according to test method NEN EN 196-1.

The shaped articles according to the present invention also show low thermal expansion, very little warping and low brittleness. For example, U.S. Pat. No. 6,583,217, incorporated by reference herein, discloses that shaped articles made from composite materials consisting of recycled PET and fly ash showed a shrinkage of 2.2% (100 wt. % recycled PET) to 0.7 wt. % (30 wt. % recycled PET, 70 wt. % of fly ash). In contrast, it was found that shrinkage of the shaped articles manufactured according to the process of the present invention was virtually independent from thermoplastic binder content.

The shaped articles may further comprise other additives commonly used in engineering stone products, e.g. pigments, colorants, dyes and mixtures thereof. The maximum amount of such additives is preferably less that about 5 wt. %, based on the total weight of the shaped article.

It is furthermore preferred that the shaped article is a slab, wherein the average thickness of the slab is about 2.5 mm to about 50 mm, more preferably about 5.0 mm to about 30 mm.

### EXAMPLES

### Example 1

Recycled PET and silica (average diameter about 0.25 mm) in a weight ratio of 16 wt. % to 84 wt. % was processed in a single-screw kneader (Buss MDK 140; L/D=11; shear rate 162 s⁻¹, residence time approximately 1 minute; 1000 kPa maximum pressure) at a temperature of 300° C. The mixture of recycled PET and silica was transferred to a press mould (temperature was 80° C.) and pressed to plates of 150 mm by 158 mm (thickness 3 mm). The press load of the mould was 2000 kN. The final plates were cooled in the open air. The plates showed no surface cracks and were not brittle.

### Example 2

This example was conducted as Example 1, but with marble as filler, wherein the weight ratio of recycled PET to marble was 16 wt. % to 84 wt. %. Shear rate was 450 s⁻¹, the residence time was 2 minutes and the maximum pressure was 400 kPa. The plates showed no surface cracks and were not brittle.

### Comparative Example 1

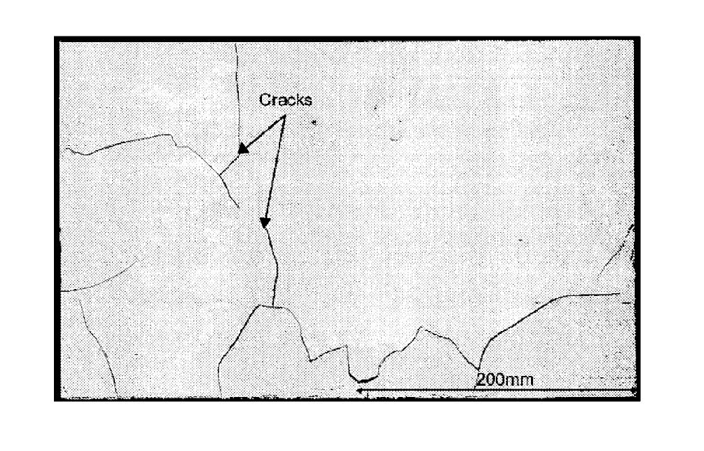

Recycled PET and sand (average diameter about 0.25 mm) in a weight ratio of 30 wt. % to 70 wt. % was processed in a single-screw extruder (Coperion Werner Pfleiderer ZSK-25; L/D=40; shear rate 1300 s⁻¹, residence time approximately 1.5 minute; 2500 kPa maximum pressure) at a temperature of 285° C. The mixture of recycled PET and sand was transferred to a press mould (temperature was 80° C.) and pressed to plates of 300 mm by 300 mm (thickness 20 mm). The press load of the mould was 2000 kN. The final plates were cooled in the open air. The plates were very brittle and showed a high number of surface cracks (cf. FIG. 1).

### Comparative Example 2

Recycled PET and silica in a weight ratio of 35 wt. % and 65 wt. % was processed in an extruder as shown in Comparative example 1. The mixture was compacted in a Kannegieser 60 S extruder at 300° C. and subsequently molded according to the procedure shown in Comparative example 1 (temperature was 180° C.). The obtained product was brittle and showed surface cracks (cf. FIG. 1).

### Example 3

Recycled PET and marble (average coarse particle diameter about 0.5 mm) in a weight ratio of 17 wt. % to 83 wt. % was processed in a twin-screw kneader (CK-100, manufactured by X-Compound GmbH; L/D=11; shear rate (max) 300 s⁻¹, shear rate (in all loading regions) 75 s⁻¹; residence time approximately 1 minute; 400 kPa maximum pressure) at a temperature of 270° C. The viscosity of the mixture was about 7000 Pa·s. The total energy per unit volume E was about 2.4*10⁹ Pa. The mixture of recycled PET and silica was fed through a 15 mm die thereby producing a plate having a thickness of about 15 mm which was transferred to a 2 m cooling table; the temperature at the start of the cooling table was about 270 C. After the cooling table the plates were left to cool with ambient air. The plates showed no surface cracks and were not brittle.

### Example 4

Recycled PET and silica/marble (weight ratio=0.42; average coarse particle diameter about 0.5 mm) in a weight ratio of 23 wt. % to 77 wt. % was processed in a single-screw kneader (Buss MDK 140; L/D=11; shear rate (max) 450 s⁻¹, shear rate (in all loading regions) 113 s⁻¹; residence time approximately 1 minute; 400 kPa maximum pressure) at a temperature of 300° C. The viscosity of the mixture was about 1700 Pa·s. The total energy per unit volume E was about 1.3*10⁹ Pa. The mixture of recycled PET and silica/marble was fed through a 15 mm die thereby producing a plate having a thickness of about 15 mm which was transferred to a cooling belt (Sandvik type DBU; temperature at the start of the cooling belt was about 270° C., temperature at the end of the cooling belt was about 90° C.; length of the cooling belt was 8 m) The plates showed no surface cracks and were not brittle.

### Example 5

Recycled PET and marble (average coarse particle diameter about 0.5 mm) in a weight ratio of 23 wt. % to 77 wt. % was processed in a single-screw kneader (CK100 manufactured by X-Compound GmbH; L/D=15; shear rate (max) 250 s⁻¹, shear rate (in all loading regions) 63 s⁻¹; residence time approximately 1 minute; 400 kPa maximum pressure) at a temperature of 270° C. The viscosity of the mixture was about 2700 Pa·s. The total energy per unit volume E was about 6.4*10⁸ Pa. The mixture of recycled PET and marble was fed through a 15 mm die thereby producing a plate having a thickness of about 15 mm which was transferred to a 2 m cooling table; the temperature at the start of the cooling table was about 270 C. After the cooling table the plates were left to cool with ambient air. The plates showed no surface cracks and were not brittle.

1. A process for manufacturing a shaped article from a composite material, said process comprising:
(a) mixing solid filler and thermoplastic binder in a kneading device at a pressure in the range of about 100 kPa to about 1500 kPa to obtain a composite material; and
(b) forming the composite material into a shaped article;
wherein the thermoplastic binder comprises about 60 wt. % to about 100 wt. % of a thermoplastic polyester, based on the total weight of the binder, and wherein the thermoplastic polyester comprises about 90 wt. % to about 100 wt. % of recycled polyethylene terephthalate.

2. The process according to claim 1, wherein the thermoplastic binder comprises about 0 wt. % to about 40 wt. % of a polyolefin.

3. The process according to claim 2, wherein the polyolefin is a propylene polymer.

4. The process according to claim 3, wherein the propylene polymer is polypropylene.

5. The process according to claim 1, wherein the solid filler and the thermoplastic binder are mixed in a weight ratio of about 1:1 to about 20:1.

6. The process according to claim 1, wherein the mixing is performed at a temperature of about 230° to about 350° C.

7. The process according to claim 1, wherein the mixing is performed at a total shear energy per unit volume of about 10⁸ Pa to about 10⁹ Pa.

8. The process according to claim 1, wherein the mixing is performed for a time period of about 30 seconds to about 5 minutes.

9. The process according to claim 1, wherein the energy input during mixing is at least about 300 kJ per kg of the solid filler and the thermoplastic binder mixture.

10. The process according to claim 1, further compacting the composite material.

11. The process according to claim 10, wherein the compacting is performed at a pressure of about 5×10³ kPa to about 5×10⁴ kPa.

12. The process according to claim 1, wherein the density of the composite material is about 1.5-3 kg/m³.

13. The process according to claim 1, wherein the shaped article has a flexural strength of at least about 40 N/mm² according to test method NEN EN 198-1.

14. The process according to claim 1, wherein the shaped article is a slab.

15. The process according to claim 14, wherein the average thickness of the slab is about 2.5 mm to about 50 mm.

16. A composite material comprising filler and thermoplastic binder, wherein the thermoplastic binder comprises about 60 wt. % to about 100 wt. % of a thermoplastic polyester, based on the total weight of the binder, and wherein the thermoplastic polyester comprises about 90 wt. % to about 100 wt. % of recycled polyethylene terephthalate.

17. The composite material according to claim 16, wherein the thermoplastic binder comprises about 0 wt. % to about 40 wt. % of a polyolefin.

18. The composite material according to claim 17, wherein the polyolefin is a propylene polymer.

19. The composite material according to claim 18, wherein the propylene polymer is polypropylene.

20. The composite material according to claim 19, comprising the solid filler and the thermoplastic binder in a weight ratio of about 1:1 to about 20:1.
